(19) United States
(12) Patent Application Publication
(10) Pub. No.: US 2003/0046561 A1
(43) Pub. Date: Mar. 6, 2003

(54) Non-algebraic cryptographic architecture

(76) Inventor: Jon W. Hamilton, Austin, TX (US)

Correspondence Address: ROBERTS ABOKHAIR & MARDULA, SUITE 1000, 11800 SUNRISE VALLEY DRIVE, RESTON, VA, 20191, US

(21) Appl. No.: 10/231,608

(22) Filed: Aug. 30, 2002

Related U.S. Application Data
(60) Provisional application No. 60/316,020, filed on Aug. 31, 2001.

(51) Int. Cl. G06F 12/14

(52) U.S. Cl. 713/189

(57) ABSTRACT

A non-algebraic cryptographic architecture. The non-algebraic cryptographic architecture is a logical implementation of a non-algebraic cryptographic engine (sometimes referred to as a “NACE”). The architecture uses a NACE in conjunction with cryptographic key lengths up to 2048 bits to achieve real-time encryption at speeds sufficient to permit wideband digital data to be decrypted in real time thereby obviating the need for store-and-forward. The architecture is inherently parallel and can accept extended block lengths, which are several multiples of the length of the cryptographic key.

### CROSS REFERENCE TO RELATED APPLICATIONS

This application claims priority under 35 U.S.C. §119(e) from provisional application No. 60/316,020, filed Aug. 31, 2001. The 60/316,020 provisional application is incorporated by reference herein, in its entirety, for all purposes.

### FIELD OF INVENTION

The present invention relates generally to data protection. More particularly, the present invention relates to the architecture of a device used to protect digital data that uses a non-algebraic method of encryption and decryption.

### BACKGROUND OF THE INVENTION

The science of keeping messages and data secure is broadly referred to as cryptology. Once an art practiced by government agencies and a few academics, cryptology has become an essential element of the digital age. The reasons for this interest in cryptology result from the consequences of going digital. Advances digital technology has enhanced our ability to distribute and store content in digital form. However, because digital data is readily transported and copied, it is inherently insecure in its raw form. Thus, to protect the content represented by digital data, a means of making the content inaccessible without interfering with the transportability or storage of the data must be found. The answer is to encrypt the digital data thus protecting the content represented by the data.

Cryptology has evolved with personal computers, so it should not come as a surprise that the large majority of cryptology solutions are designed for a computer. In its current state, cryptology has developed cryptographic algorithms based on algebraic equations and mathematical operations that can be readily performed on a computer. Computational complexity of algorithms is sometimes measured in terms of the computing power needed to execute it for a given sized input. The larger the input, the slower the computation time. Algebraically strong algorithms, such as exponential algorithms are not feasible for large data inputs.

Secure protection by a cryptographic algorithm means that it is not breakable by cryptanalytic techniques, which would allow one to decrypt the encrypted version without prior knowledge of the cryptographic key. A secure cryptographic algorithm that is not breakable can be attacked only by an exhaustive search of all combinations of its cryptographic keys, i.e., the “brute force attack”. In this method of attack, adversaries use all combinations of the cryptographic key together with knowledge of the cryptographic algorithm and encrypted text.

One approach to securing an algorithm is to increase the key length to increase the number of possible combinations of keys that must be attempted in a brute force attack. The current “gold standard” for the length of a cryptographic key to protect financially sensitive data is 128 bits. Wideband data protected by a secure 128 bit cryptographic algorithm requires an adversary to examine over 3.4×10³⁸ potential keys. This is not technically feasible now, and is unlikely to be feasible within the next ten years given the current rate of progress in digital data processing systems.

In the algebraic cryptographic world, the cryptographic process is optimized on the speed of the encryption function. Additionally, the size of the block of data is generally limited to the key length to enhance the security of the encrypted data by reducing the possibility of redundancies and statistical relationships between the data being encrypted (the plaintext) and the encrypted output (the ciphertext). These two limitations of the algebraic approach to encryption of data must be overcome when protecting large bandwidth blocks of data that must be decrypted in real-time. Moreover, the solution to these limitations must be easily implemented in hardware form for the market for wideband consumer and business products to reach its potential.

To give this observation perspective, if the content of a video produced by a digital video camera were encrypted using a 128-bit key, to match the quality of the unencrypted content would require a decryption speed on the order of 10⁷ bits per second. An HDTV-quality image encrypted with a 128-bit key would require a decryption speed of between 10⁷ and 10⁸ bits per second.

The first generation of digital cinemas requires wideband digital imagery. This has two components, first the total number of digital imagery bits and second, the rate in bits per second that the digital imagery product must be displayed. The first generation of digital cinemas requires a data rate of 1.8×10⁹ bits per second. This arises from a digital cinema product that displays 30 frames per second, frames of 2×10⁶ pixels, and pixels consisting of 30 bits each. If the digital cinema product is 1.5 hours long, then the total number of bits is 9.720×10¹² bits. Subsequent generations of digital cinema products will growth to 70 frames per second, frames of 10⁷ pixels, and pixels of 36 bits each, requiring a data rate of 2.52×10¹⁰ bits per second, with data storage for the image of 1.37×10¹⁴ bits.

Providing content protection and storage for these data rates and quantities of data are daunting tasks. Data compression can help in both matters, by reducing the amount of data per frame, thus decreasing both storage requirements and data rates. However, it is an open question amongst cinematic producers as to the degree of compression that is acceptable without impact the artistic integrity of their product. In addition only compression techniques that adversely affect image quality provide any significant degree of data compression, and upon decompression do not produce the same quality image as before compression. In either case, with compression ratios limited to less than 10:1 and most probably less than 5:1 data, compression will not have a major effect on the data rate. Thus digital cinema projection systems using data compression would currently experience data rates of from 0.18×10⁹ bits per second up to 0.36×10⁹ bits per second. Succeeding generations of digital cinema would require data rates between 0.252×10¹⁰ bits per second to 0.504×10¹⁰ bits per second.

Today, assuming a 128-bit key, the best encryption speed is about 2×10⁸ bits per second and the best decrypt speed is about 2×10⁷ bits per second. For this reason, large digital files are not encrypted, the key length is kept short to increase speed, or the key to decrypt them is entrusted to a third party. More importantly, products based on wideband digital data distribution that permit use of such data while protecting the content originator's ownership interest remain in the conceptual stage.

What is needed is an architecture for a device capable of encrypting and decrypting digital cinema products at data rates between 0.252×10¹⁰ bits per second to 0.504×10¹⁰ bits per second so that the digital content can be decrypted in real time thereby obviating the need for store-and-forward.

### SUMMARY OF THE INVENTION

The present invention is embodied as a non-algebraic cryptographic architecture of a device for encrypting and decrypting digital cinema products in real time.

It is an object of the present invention to be a secure method for the encryption and decryption of wideband data.

It is a further object of the present invention to take maximum advantage of the inherent parallel structures of the NACE cryptographic algorithm.

It is a further object of the present invention to have variable cryptographic key lengths of from 128 bits to 2048 bits.

It is yet another object of the present invention to encrypt and decrypt at speeds at least 10 times faster than algebraic cryptographic algorithms with a cryptographic key length of 128 bits.

It is yet another object of the present invention to encrypt and decrypt at speed in excess of 10¹⁰ bits per second, using a custom hardware implementation.

It is yet another object of the present invention to be a block cipher cryptographic algorithm with feedback cipher products in the generation of encrypted text data and in the generation of exchanged cryptographic keys.

It is yet another object of the present invention to allow for a wide variety of processor implementations conforming to the processor system architecture.

These and other objectives of the present invention will become apparent from a review of the general and detailed descriptions that follow. An embodiment of the present invention is a non-algebraic cryptographic architecture. In an exemplary embodiment of the present invention, this architecture is implemented as a “controller”. The architecture of the controller is a logical implementation of a nonalgebraic cryptographic engine (sometimes referred to as a “NACE”). A non-algebraic cryptographic engine meeting the requirements of the present invention is described in U.S. Patent Application entitled “Non-Alebraic Method of Encryption and Decryption” and filed on Aug. 30, 2002, which patent application is hereby incorporated by reference herein, in its entirety, for all purposes. (This patent is application is sometimes referred to herein as the “NACE Application”). The controller uses a NACE in conjunction with cryptographic key lengths up to 2048 bits to achieve real-time encryption at speeds sufficient to support the current and future digital cinema requirements described above.

The architecture is inherently parallel and admits extended block lengths, which are several multiples of the length of the cryptographic key. The controller is optimized for its decryption speed and to process wideband digital data.

The non-algebraic cryptographic architecture may be implemented by means well known in the art. By way of illustration and not as a limitation, the architecture may be implemented as a network of microprocessors, a network of digital processors, or as one or more custom ASIC chips, without departing from the scope of the present invention.

### BRIEF DESCRIPTION OF THE DRAWINGS

A better understanding of the present invention will be realized from the detailed description that follows, taken in conjunction with the accompanying drawings, in which:

FIG. 1 is a block diagram illustrating an encryption architecture according to the present invention.

FIG. 2 is a flow diagram illustrating the data and command flows of an encryption architecture according to the present invention.

FIG. 3 is a block diagram illustrating a decryption architecture according to the present invention.

FIG. 4 is a flow diagram illustrating the data and command flows of a decryption architecture according to the present invention.

### DETAILED DESCRIPTION OF THE INVENTION

An embodiment of the present invention is a non-algebraic cryptographic (NAC) architecture. In one embodiment according to the present invention, the NAC architecture is implemented as a “controller”. This embodiment is described in terms of its logical architecture. The reference to a “processor”, for example, is not a reference to a discrete component but to a logical element that performs the task of a processor. In this embodiment, a logical processor may comprise one or more discrete processors or may comprise elements of an integrated circuit that perform a referenced task.

The controller can take two forms: an encryption controller or a decryption controller. An encryption embodiment of the non-algebraic cryptographic controller operates in the encryption mode of the NACE. A decryption embodiment of the non-algebraic cryptographic controller operates in the decryption mode of the NACE. Each of these embodiments is described separately. The first segment of the description illustrates the functionality of an embodiment according to the present invention. The second segment is a detailed description of the data flows involved between the individual logical elements of that embodiment.

A. Encryption Embodiment

1. Functional Description

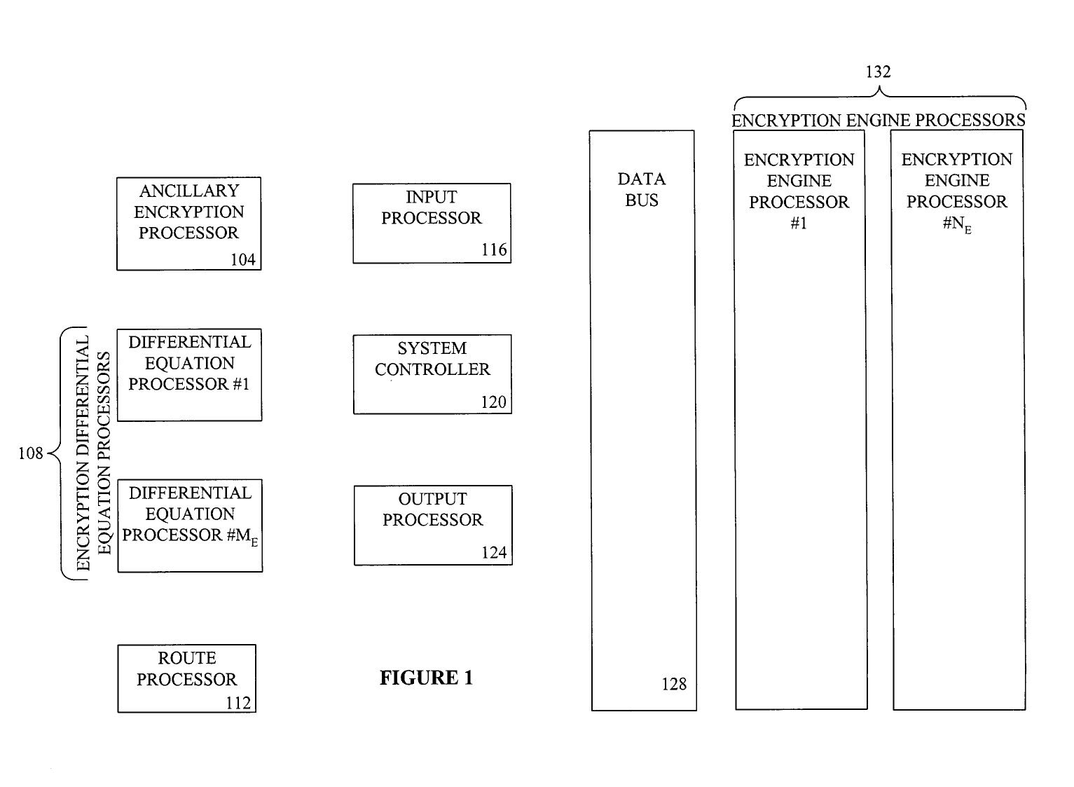

A block diagram of the system architecture of an encryption embodiment of the present invention is illustrated in FIG. 1. Referring to FIG. 1, the system architecture for the encryption controller comprises eight distinct types of logical processors: ancillary encryption processor 104; differential equation processors 108; route processor 112; input processor 116; system controller 120; output processor 124; data bus 128; and encryption engine processor 132.

As illustrated in FIG. 1, an encryption embodiment of the present invention utilizes multiple independent differential equation processors 108 numbering M_{E} Additionally, the ancillary encryption processor 104 performs pre-computation processing of ancillary data (as described below) before any encryption processing is initiated. Computations by the differential equation processors 108 and the route processor 112 are done in parallel with the encryption processing by the encryption engine processors 132. The combination of pre-computation and parallel processing itself to extremely high encryption rates.

The NACE generates ancillary data during the encryption mode, which data is subsequently used in the decryption mode to decrypt cipher text created using the NACE in the encryption mode. By retaining this data, no additional computational resources are needed during decryption to recreate it, resulting in significant improvement in processing speed. As noted, the ancillary encryption processor 104 generates seed data, based on the system controller's clock; performs the ancillary cryptographic key exchange, with the ancillary cryptographic key contained in static storage within the system controller 120; generates the exchanged ancillary cryptographic keys; performs the primary cryptographic key exchange, with the primary cryptographic key contained in static storage within the system controller 120; generates the exchanged primary cryptographic keys; generates the required and appropriate number of random numbers; receives and stores all ancillary data; and encrypts all the ancillary data.

As disclosed in detail in the NACE Application, the non-algebraic cryptographic engine utilizes uses nonlinear equations and analysis, instead of algebraic equations, to generate cipher products to encrypt digital data. Certain classes of these equations have properties referred to as “attractors” that evolve from nonlinear differential equations, nonlinear partial differential equations, and nonlinear difference equations. “Routes” generated by a route constructor using random numbers are used to determine a time history along a trajectory of an attractor. The route parameters are computed for a specific route by using the time domain history contained in a route to find solution points on an attractor. These solution points are unique and intractable.

The differential equation processors 108 select the field of coefficient; select the nonlinear differential equation, or nonlinear partial differential equation, or nonlinear difference equation; generate the solution space based on a pre-selected numerical integration technique; and store the solutions in form suitable and appropriate for subsequent processing.

Because of the processing load inherent in the differential equation processor function, several parallel differential equation processors are utilized. The number of such processors is denoted by ME, and is determined by the specific implementation of the processor system architecture.

The route processor 112 generates and sets the step intervals for all routes and generates all the routes required by the encryption engine processor.

The system controller 120 manages a primary and an ancillary cryptographic keys, both held in static memory; and structures and organizes all of the processing for the encryption processors 132, including, but not limited to, initiation of processing, routing of data, and maintaining timing and data transfers of all other processors. In an alternate embodiment of the present invention, an external authentication center is used to authenticate the originator and to exchange keys. In this alternate embodiment, the system controller 120 also establishes and verifies the authenticity of the originator through two-way communications with the systems authentication center.

The NACE receives digital data in block form. The processing of wideband digital data is performed by first partitioning the wideband data and processing the partitioned data in parallel. The input processor 116 receives all of the original copy of wideband digital data; partitions the incoming data into the appropriate number of channels; and partitions the channelized data into frames of clear text data.

The output processor 124 receives both the encrypted ancillary data and the encrypted version of the original copy of wideband digital data and stores both encrypted data files for retrieval during the decryption process.

The data bus 128 routes within the accepted timelines and data bandwidths, data between all of the processors of this encryption embodiment.

The encryption engine processor 132 encrypts the original copy of the wideband digital data, using the encryption mode of a NACE. The NACE Application also disclosed optional smoothing functions ELS1, ENLS1, ELS2, and ENLS2. An encryption embodiment of the present invention implements these functions along with the ES function in the encryption engine processor 132. However, as would be apparent to someone skilled in the art of the present invention, these optional smoothing functions may be omitted without departing from the scope of the present invention.

Because of the processing load inherent in the encryption engine processor function, several parallel encryption engine processors are utilized. The number of such processors is denoted by N_{E}, and is determined by the specific implementation of the system architecture of the encryption processor.

In an encryption embodiment of the present invention, each encryption engine processor simultaneously receives channelized and framed data of the original copy of wideband digital data. Thus, the original wideband digital data is being processed using parallel processing resulting in extremely high encryption data rates.

2. Data Flow

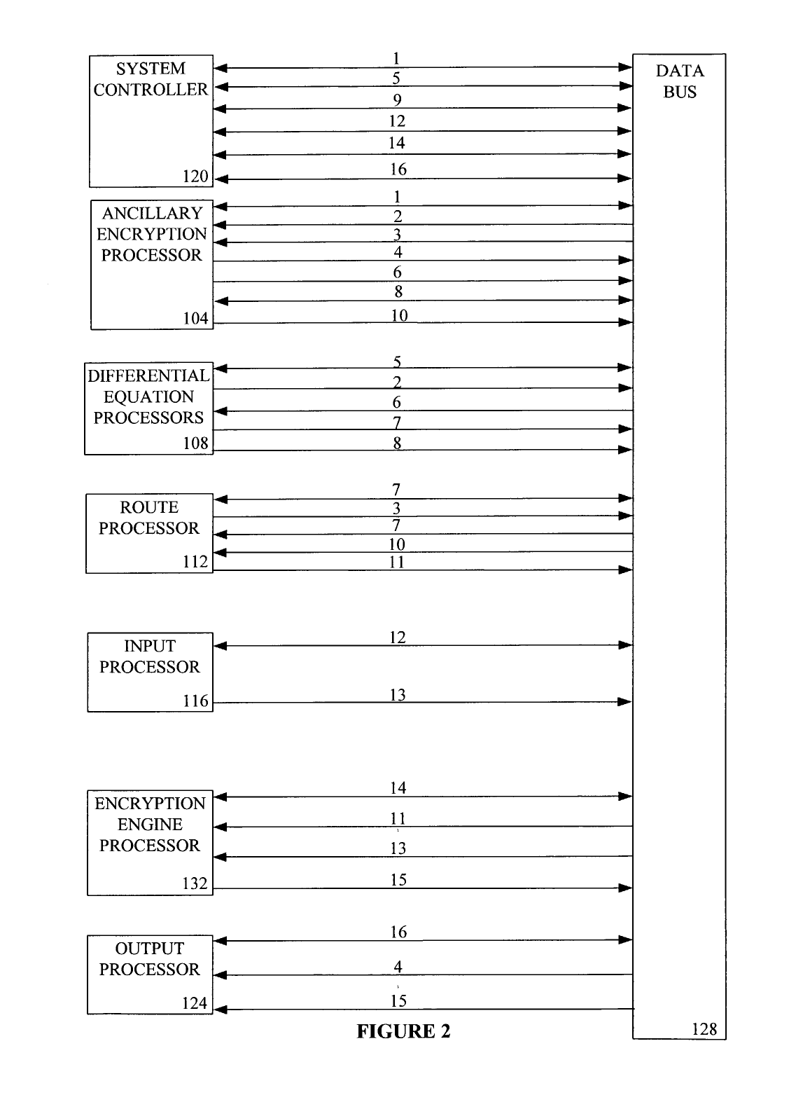

FIG. 2 contains a flow diagram that illustrates the information and data flow within the system architecture for an encryption embodiment. Within FIG. 2 the arrows indicate the directionality of the data flow for both information and control types of data. A bidirectional arrow indicates communication between two processors, whereas a single direction arrow indicates data transfer from one processor to another. All of the processors previously described access data and interchange data and information through the data buss 128. All of the processors are activated and controlled by the system controller 120 through the data bus.

The flow of the encryption process of an original copy of wideband digital data begins with pre-computation processing. The ancillary encryption processor 104 begins the procedure by importing the primary and ancillary cryptographic keys from the system controller 120. This is under commands from the system controller 120 and is indicated by arrow ‘1’ in FIG. 2. This path also represents the system controller 120 performing its housekeeping task of checking status through an interrupt handling procedure. Next the ancillary encryption processor 104 extracts system clock data from the system controller 120 to initialize and generate seed data. The ancillary encryption processor 104 generates random numbers and both the primary and ancillary exchanged cryptographic keys. These data are retained by the ancillary encryption processor in its ancillary data file. During subsequent pre-computation processing, additional ancillary data is generated by the differential equation processors 108 and by the route processor 112. These data are sent via the data bus 128 to the ancillary encryption processor where they are stored in the ancillary data file as indicated in FIG. 2 by the arrows ‘2’ and ‘3’, respectively. When the ancillary data is completed, the ancillary encryption processor proceeds to encrypt the ancillary data and then exports this data via the data bus to the output processor 124, which is indicated in FIG. 2 by arrow ‘4’.

The differential equation processors 108 begin their activity after the ancillary encryption processor 104 has generated the random number file and the exchanged ancillary cryptographic keys. This is under commands from the system controller and is indicated by arrow ‘5’ in FIG. 2. This path also represents the system controller 120 performing its housekeeping task of checking status through an interrupt handling procedure. The differential equation processors 108 generate the solution spaces for the differential equations using ancillary data from the ancillary encryption processor, indicated by arrow ‘6’ and then export them via the data bus to the route processor 112, which is indicated in FIG. 2 by arrow ‘7’. The differential equation processors also produce certain ancillary data which are exported via the data bus to the ancillary encryption processor 104, which is indicated in FIG. 2 by arrow ‘8’.

The route processor 112 begins its processing after the differential equation processors 108 have generated sufficient solution spaces for its processing activities. This is under command from the system controller 120 and is indicated by arrow ‘9’ in FIG. 2. This path also indicates the system controller 120 performance of its housekeeping task of checking status through an interrupt handling procedure. The route processor 112 uses data from both the ancillary encryption processor 104 and the differential equation processors 108 as is indicated in FIG. 2 by arrow ‘7’ and ‘10’, respectively. The route processor 112 then generates routes and then uses them and the solution space information generated by the differential equation processors 108 to generate route data. Under the timing command of the system controller 120, the route processor 112 exports its data to the encryption engine processors 132, which is indicated in FIG. 2 by arrow ‘11’.

When the ancillary encryption processor, the differential equation processors, and the route processor have completed the pre-computation tasks, then the encryption of the original copy of wideband digital data can begin through the importing of these data by the input processor 116. This is under commands from the system controller 120 and is indicated by arrow ‘12’ in FIG. 2. This path also indicates the system controller 120 performance of its housekeeping task of checking status through an interrupt handling procedure. The input processor 124 channelizes the data and arranges the data into appropriate frames for subsequent processing. Upon command of the system controller 120, the input processor then exports frames of original copy of wideband digital data frames to one of the encryption engine processors 132, as is indicated by arrow ‘13’ in FIG. 2.

Each of the encryption engine processors 132 begins processing a frame of wideband digital data. This processing is under commands from the system controller 120 and is indicated by arrow ‘14’ in FIG. 2. This path also indicates the system controller 120 performance of its housekeeping task of checking status through an interrupt handling procedure. An encryption engine processor 132 also receives route data via the data bus 128 from the route processor 112 as is indicated by arrow ‘11’ in FIG. 2. Upon the completion of its encryption processing, each of the encryption engine processors 132 send the now encrypted data to the output processor 124 via the data bus 128 as is indicated by arrow ‘15’ in FIG. 2.

The output processor 124 begins its processing upon the receipt and command of the system controller 120 as indicated by arrow ‘16’ in FIG. 2. This path also indicates the system controller 120 performance of its housekeeping task of checking status through an interrupt handling procedure. The output processor 124 receives data from both the ancillary encryption processor 104 and each of the encryption engine processors 132. The output processor segregates the ancillary data from the encrypted version of the original copy of wideband digital data. Upon receiving encrypted wideband digital data, the output processor 132 recombines the frames and channels into a single file of encrypted original copy of wideband digital data.

B. A Decryption Embodiment

1. Functional Description

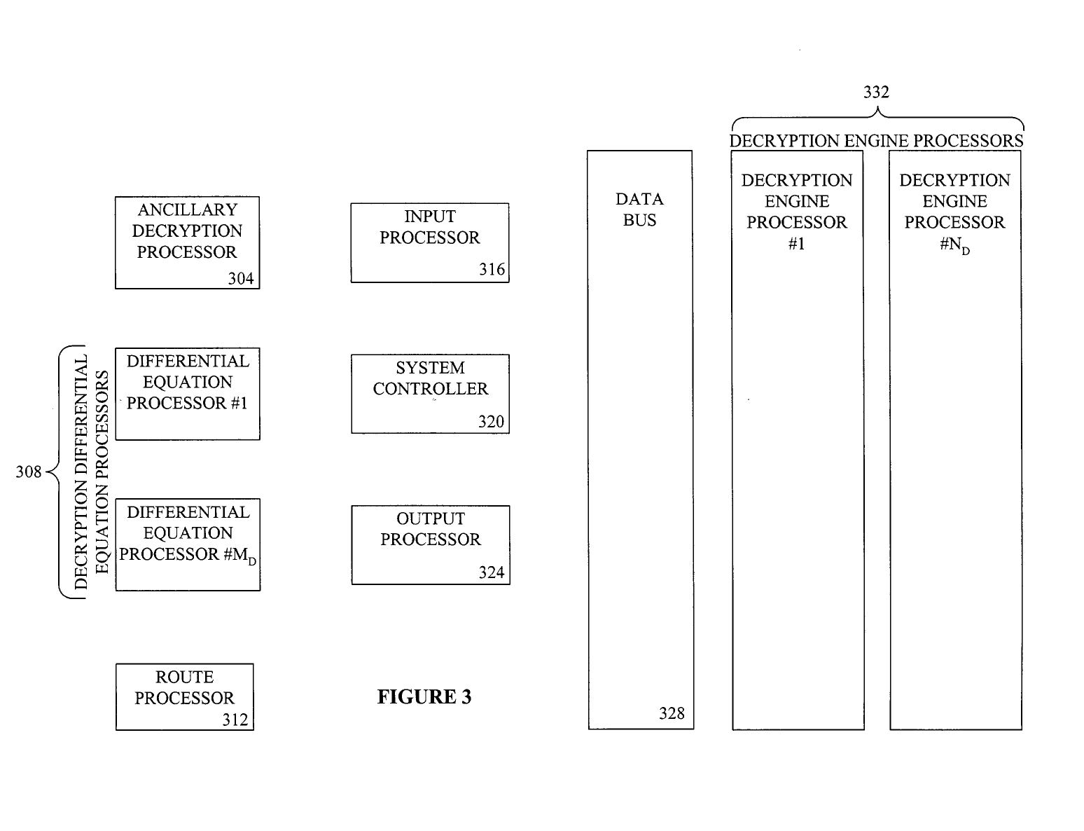

A block diagram of the system architecture of a decryption embodiment of the present invention is illustrated in FIG. 3. Referring to FIG. 3, the system architecture for the decryption processor comprises eight distinct types of logical processors: ancillary encryption processor 304; differential equation processor 308; route processor 312; input processor 316; system controller 320; output processor 324; data bus 328; and encryption engine processor 332.

As illustrated in FIG. 3, a decryption embodiment of the present invention utilizes multiple independent differential equation processors 308 numbering MD and Additionally, the ancillary decryption processor 304 performs pre-computation processing of ancillary data (as described below) before any decryption processing is initiated. Computations by the differential equation processors 308 and the route processor 312 are done in parallel with the decryption processing by the decryption engine processors 332. The combination of pre-computation and parallel processing itself to extremely high decryption rates.

As described above in relation to an encryption embodiment of the present invention, ancillary data generated during the encryption process is saved for use in the decryption of the encrypted wideband data. Referring again to FIG. 3, the ancillary decryption processor 304 decrypts the ancillary data and regenerates the exchanged primary cryptographic keys and exchanged ancillary cryptographic keys.

The differential equation processors 308 use ancillary data to generate a solution spaces based on a pre-selected numerical integration technique; and then store the solutions in form suitable and appropriate for subsequent processing. Because of the processing load inherent in the differential equation processor function, several parallel differential equation processors may be utilized. The number of such processors is denoted by M_{D}, and is determined by the specific implementation of the system architecture of processors.

The route processor 312 generates and sets the step intervals for all routes and generates all the routes required by the decryption engine processor.

The system controller 320 manages a primary and an ancillary cryptographic key, both held in static memory, and structures and organizes all of the processing for the decryption processors 332, including, but not limited to, initiation of processing, routing of data, and maintaining timing and data transfers of all other processors. In an alternate embodiment of the present invention, an external authentication center is used to authenticate the user and to exchange keys. In this alternate embodiment, the system controller 320 also establishes and verifies the authenticity of the user through two-way communications with the systems authentication center

The input processor 316 receives the files of encrypted ancillary data and the encrypted version of the original wideband digital data; separates the encrypted ancillary data from the encrypted version of the original wideband digital image data; partitions the encrypted wideband digital data into the appropriate number of channels; and partitions the channelized data into frames.

The output processor 324 receive the clear text version of the original copy of the wideband digital data from the decryption engine processors 332, puts the frame and channel data back into the original order; and transmits the clear text wideband digital data to a user device such as a projector or display system.

The data bus 328 routes, within the accepted timelines and data bandwidths, all of the data between all of the processors of a decryption embodiment.

The decryption engine processor 332 decrypts the encrypted version of the original wideband digital data using the decryption mode of a NACE. The NACE Application also disclosed optional smoothing functions DNLS2, DLS2, DNLS1, and DLS1. A decryption embodiment of the present invention implements these functions along with the DS function in the decryption engine processor 332. However, as would be apparent to someone skilled in the art of the present invention, these optional smoothing functions may be omitted without departing from the scope of the present invention

Because of the processing load inherent in the decryption engine processor function, several parallel decryption engine processors may be utilized. The number of such processors is denoted by ND, and is determined by the specific implementation of the system architecture of the decryption processor.

In a decryption embodiment of the present invention, each decryption engine processor receives channelized and framed data of the encrypted version of the original wideband digital data. Thus, the encrypted wideband digital data is being processed using parallel processing resulting in extremely high decryption data rates.

2. Logical Flow

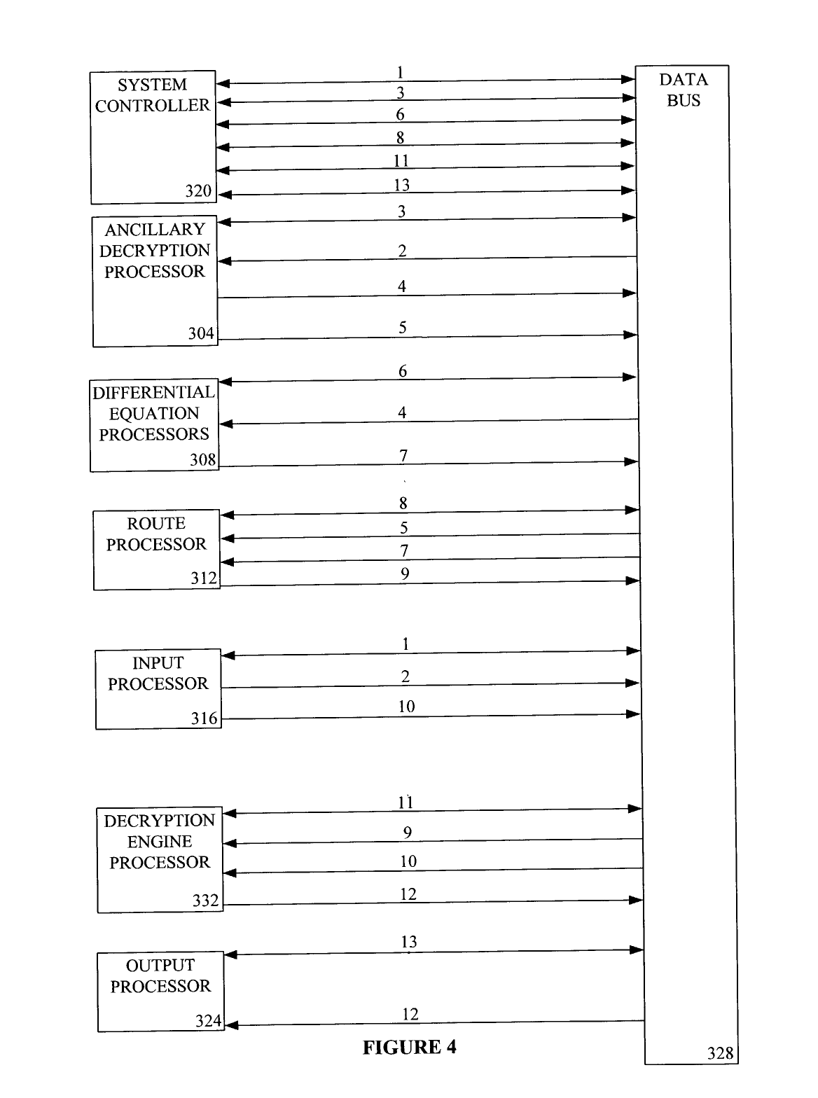

FIG. 4 contains a flow diagram that illustrates the information and data flow within the system architecture for the decryption processor. Within FIG. 4 the arrows indicate the directionality of the data flow, for both information and control types of data. A bidirectional arrow indicates communication between two processors, whereas a single direction arrow indicates data transfer from one process to another. All of the processors previously described access data and interchange through the data buss 328. All of the processor modules are activated and controlled by the system controller 320 through the data bus.

The flow of the decryption process of an encrypted version of the wideband digital data begins with a command from the system controller to the input processor 316 to initiate the decryption. This is described by arrow ‘1’ in FIG. 4. The input processor 316 then imports all of the encrypted files. The encrypted files comprise two distinctly different types of data: the encrypted ancillary data files and the encrypted version of the original copy of the wideband digital data. The input processor 316 strips the encrypted ancillary data file and sends it to the ancillary decryption processor 304 via the data bus as is indicated by arrow ‘2’ in FIG. 4.

The ancillary decryption processor 304 receives the encrypted ancillary data files. This is under commands from the system controller 320 and is indicated by arrow ‘3’ in FIG. 4. This path also represents the system controller 320 performing its housekeeping task of checking status through an interrupt handling procedure. The receipt of the encrypted ancillary data files from the input processor 116 is indicated by arrow ‘2’ in FIG. 4. This initiates the pre-computation phase of the decryption process. The ancillary decryption processor 304 decrypts the encrypted ancillary data file to recover the original ancillary data, which comprises seed data, random numbers, and route constructor data. This data is then transmitted to the differential equation processors 308 and the route processor 312 using the data bus 328 and is indicated in FIG. 4 by arrow ‘4’ and arrow ‘5’, respectively. The ancillary decryption processor 304 also uses ancillary data and the primary and ancillary cryptographic keys to regenerate the exchanged primary and ancillary cryptographic keys. These data are retained by the ancillary decryption processor for subsequent use in the decryption processing.

The differential equation processors 308 begin their activity after the ancillary encryption processor 304 has generated the exchanged ancillary cryptographic keys and decrypted the encrypted ancillary data. This is under commands from the system controller 320 and is indicated by arrow ‘6’ in FIG. 4. This path also represents the system controller 320 performing its housekeeping task of checking status through an interrupt handling procedure. The differential equation processors 308 generate the solution spaces for the differential equations using ancillary data from the ancillary decryption processor 304, indicated by arrow ‘4’ and then exports the solution spaces via the data bus 328 to the route processor 312, which is indicated in FIG. 4 by arrow ‘7’.

The route processor 312 begins its processing after the differential equation processors 308 have generated sufficient solution spaces for its processing activities. This is under commands from the system controller 120 and is indicated by arrow ‘8’ in FIG. 4. This path also represents the system controller 320 performing its housekeeping task of checking status through an interrupt handling procedure. The route processor 312 uses data from both the ancillary decryption processor 304 and the differential equation processors 308 as is indicated in FIG. 4 by arrows ‘5’ and ‘7’, respectively. The route processor 308 generates routes and then uses them and the solution space information generated by the differential equation processors 308 to generate route data. Under the timing command of the system controller 320, the route processor exports its data to the decryption engine processors 332, which is indicated in FIG. 4 by arrow ‘9’.

When the ancillary decryption processor, the differential equation processors, and the route processor have completed the pre-computation tasks, then the decryption of the encrypted version of the original clear wideband digital data can begin. This process is controlled by commands from the system controller 320 and is indicated by arrow ‘1’ in FIG. 4. This path also represents the system controller 320 performing its housekeeping task of checking status through an interrupt handling procedure.

The process begins with the receipt of the encrypted original copy of the wideband digital data by the input processor 316. The input processor 316 channelizes the data and arranges the channelized data into appropriate frames for subsequent processing. Upon command of the system controller 320, the input processor 316 then exports the frames of the encrypted wideband digital data frames to one of the decryption engine processors 332, as is indicated by arrow ‘10’ in FIG. 4.

Each of the decryption engine processors 332 begins processing of a frame of encrypted wideband digital data under the control of the system controller 320 and is indicated by arrow ‘11’ in FIG. 4. This path also represents the system controller 320 performing its housekeeping task of checking status through an interrupt handling procedure. The encryption engine processor 332 also receives route data via the data bus 328 from the route processor 312 as is indicated by the arrow ‘9’ in FIG. 4. Upon the completion of its decryption processing, each of the decryption engine processors 332 sends the now decrypted data to the output processor 324 via the data bus 328 as is indicated by arrow ‘12’ in FIG. 4.

The output processor 324 begins its processing upon the receipt under command of the system controller 320 and is indicated by arrow ‘13’ in FIG. 4. This path also represents the system controller 320 performing its housekeeping task of checking status through an interrupt handling procedure. The output processor 324 then puts the frames and channels back into the original order for transmission to a user device, such as a projector or display system.

A non-algebraic cryptographic architecture has been described. As described herein, the non-algebraic cryptographic architecture provides for protection of wideband digital data while permitting such data to be encrypted and decrypted at speeds that satisfy the data rates required by both current and future wideband applications. Additionally, the present invention has achieved the aforementioned high data rates without requiring the intermediate storage of any clear text wideband digital data. It will be understood by those skilled in the art of the present invention that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A device architecture for implementing a wideband digital data encryptor using a non-algebraic cryptographic engine, wherein the architecture comprises a system controller in communication over a data bus with an input processor; an ancillary encryption processor; a differential equation processor; a route processor; an encryption engine processor; and an output processor, wherein:
the system controller comprises logic for:
managing a primary and an ancillary cryptographic key;
initiating processing, routing data, and maintaining timing and data transfers among the ancillary encryption processor; differential equation processor;
route processor, input processor, output processor, and encryption engine processor within the accepted timelines and data bandwidths; and
the input processor comprises logic for:
receiving wideband digital data; and
partitioning the wideband digital data into a plurality of frames; and
the ancillary encryption processor comprises logic for:
generating seed data;
receiving the ancillary cryptographic key from the system controller;
generating an exchanged ancillary cryptographic key;
receiving the primary cryptographic key from the system controller;
generating an exchanged primary cryptographic key;
generating random numbers;
receiving, storing, and encrypting ancillary data; and
the differential equation processor comprises logic for:
selecting a nonlinear equation, wherein the nonlinear equation has as a solution set a strange attractor;
selecting a coefficient field for the nonlinear equation;
receiving random numbers;
generating solution space data of the nonlinear equation;
storing the solution space data for subsequent processing;
the route processor comprises logic for:
receiving the solution space data;
generating the step intervals for a route; and
generating a route based on the step interval; and
the encryption engine processor comprises logic for:
encrypting the wideband digital data using the encryption mode of a nonalgebraic cryptographic engine; and
generating ancillary data during the encryption mode;
sending the ancillary data to the ancillary encryption processor; and
the output processor comprises logic for:
receiving and storing encrypted ancillary data;
receiving and storing encrypted wideband digital data.

2. The device architecture of claim 1 wherein the device is an integrated circuit.

3. The device architecture of claim 1 wherein the system controller further comprises logic for executing the logic of the ancillary encryption processor, the differential equation processor, and the route processor prior to executing the logic of the encryption engine processor.

4. The device architecture of claim 3 wherein the device is an integrated circuit.

5. The device architecture of claim 3 wherein the device architecture further comprises a plurality of differential equation processors and a plurality of encryption engine processors and wherein the system controller further comprises logic for:
independently instructing each of the plurality of differential equation; and
simultaneously routing a frame to each of the plurality of encryption engine processors for processing in parallel.

6. The device architecture of claim 5 wherein the device is an integrated circuit.

7. A device architecture for implementing a decryptor of wideband digital data encrypted using a non-algebraic cryptographic engine, wherein the architecture comprises a system controller in communication over a data bus with an input processor, an ancillary decryption processor, a differential equation processor, a route processor; a decryption engine processor, and an output processor, wherein:
the system controller comprises logic for:
managing a primary and an ancillary cryptographic key;
initiating processing, routing data, and maintaining timing and data transfers among the input processor, the ancillary decryption processor, the differential equation processor; the route processor, the decryption engine processor, and the output processor within the accepted timelines and data bandwidths; and
the input processor comprises logic for:
receiving encrypted ancillary data;
sending the encrypted ancillary data to the ancillary decryption processor;
receiving encrypted wideband digital data;
partitioning the encrypted wideband digital data into a plurality of frames; and
sending a frame to a decryption engine processor; and
the ancillary decryption processor comprises logic for:
decrypting the encrypted ancillary data to produce clear text ancillary data comprising seed data, random numbers, and route constructor data;
receiving the ancillary cryptographic key from the system controller;
regenerating from the ancillary data and the ancillary cryptographic key an exchanged ancillary cryptographic key;
receiving the primary cryptographic key from the system controller; and
regenerating from the ancillary data and the primary cryptographic key an exchanged primary cryptographic key; and
the differential equation processor comprises logic for:
obtaining clear text ancillary data;
regenerating solution spaces based on ancillary data;
storing the solution space for subsequent processing;
the route processor comprises logic for:
generating the step intervals for a route; and
generating a route based on the step interval; and
the decryption engine processor comprise logic for decrypting frames of encrypted wideband digital data using the decryption mode of a non-algebraic encryption engine to produce frames of clear text wideband digital data; and
the output processor comprising logic for:
receiving and storing clear text ancillary data;
receiving and storing frames of clear text wideband digital data;
placing the frames of clear text data wideband digital data in the order of the frames of wideband digital data prior to encryption; and
sending the clear text wideband digital data to a user device.

8. The device architecture of claim 7 wherein the device is an integrated circuit.

9. The device architecture of claim 7 wherein the device architecture further comprises a plurality of differential equation processors and a plurality of decryption engine processors and wherein the system controller further comprises logic for:
independently instructing each of the plurality of differential equation; and
simultaneously routing a frame to each of the plurality of decryption engine processors for processing in parallel.

10. The device architecture of claim 9 wherein the device is an integrated circuit.

11. A wideband digital non-algebraic data encryption device, the device comprising:
a system controller;
a data bus;
an input processor in communication with the system controller via the data bus;
an ancillary encryption processor in communication with the system controller via the data bus;
a differential equation processor in communication with the system controller via the data bus;
a route processor in communication with the system controller via the data bus;
an encryption engine processor in communication with the system controller via the data bus;
an output processor in communication with the system controller via the data bus; and
memory accessible by the system controller, the input processor, the ancillary encryption processor, the differential equation processor, the route processor, the encryption engine processor, and the output processor;
wherein the memory bears software instructions that enable the system controller to effect the steps of:
managing a primary and an ancillary cryptographic key; and
initiating processing, routing data, and maintaining timing and data transfers among the ancillary encryption processor; differential equation processor; route processor, input processor, output processor, and encryption engine processor;
wherein the memory bears software instructions that enable the input processor to effect the steps of:
receiving wideband digital data; and
partitioning the wideband digital data into a plurality of frames;
wherein the memory bears software instructions that enable the ancillary encryption processor to effect the steps of:
generating seed data;
receiving the ancillary cryptographic key from the system controller;
generating an exchanged ancillary cryptographic key;
receiving the primary cryptographic key from the system controller;
generating an exchanged primary cryptographic key;
generating random numbers; and
receiving, storing, and encrypting ancillary data;
wherein the memory bears software instructions that enable the differential equation processor to effect the steps of:
selecting a nonlinear equation, wherein the nonlinear equation has as a solution set a strange attractor;
selecting a coefficient field for the nonlinear equation;
receiving random numbers;
generating solution space data of the nonlinear equation;
storing the solution space data for subsequent processing;
wherein the memory bears software instructions that enable the route processor to effect the steps:
receiving the solution space data;
generating the step intervals for a route; and
generating a route based on the step interval;
wherein the memory bears software instructions that enable the encryption engine processor to effect the steps:
encrypting the wideband digital data using the encryption mode of a non-algebraic cryptographic engine; and
generating ancillary data during the encryption mode;
sending the ancillary data to the ancillary encryption processor; and
wherein the memory bears software instructions that enable the output processor to effect the steps:
receiving and storing encrypted ancillary data; and
receiving and storing encrypted wideband digital data.

12. The device architecture of claim 11 wherein the device is an integrated circuit.

13. A wideband digital non-algebraic data decryption device, the device comprising:
a system controller;
a data bus;
an input processor in communication with the system controller via the data bus;
an ancillary decryption processor in communication with the system controller via the data bus;
a differential equation processor in communication with the system controller via the data bus;
a route processor in communication with the system controller via the data bus;
an decryption engine processor in communication with the system controller via the data bus;
an output processor in communication with the system controller via the data bus; and
memory accessible by the system controller, the input processor, the ancillary decryption processor, the differential equation processor, the route processor, the decryption engine processor, and the output processor;
wherein the memory bears software instructions that enable the system controller to effect the steps of:
managing a primary and an ancillary cryptographic key; and
initiating processing, routing data, and maintaining timing and data transfers among the ancillary decryption processor; differential equation processor; route processor, input processor, output processor, and decryption engine processor;
wherein the memory bears software instructions that enable the input processor to effect the steps of:
receiving encrypted ancillary data;
receiving encrypted wideband digital data; and
partitioning the encrypted wideband digital data into a plurality of frames;
wherein the memory bears software instructions that enable the ancillary decryption processor to effect the steps of:
receiving the encrypted ancillary data from the input processor;
decrypting the encrypted ancillary data to produce clear text ancillary data comprising seed data, random numbers, and route constructor data;
receiving the ancillary cryptographic key from the system controller;
regenerating from the ancillary data and the ancillary cryptographic key an exchanged ancillary cryptographic key;
receiving the primary cryptographic key from the system controller; and
regenerating from the ancillary data and the primary cryptographic key an exchanged primary cryptographic keydecrypt
wherein the memory bears software instructions that enable the differential equation processor to effect the steps of:
obtaining clear text ancillary data;
regenerating solution spaces based on ancillary data;
storing the solution space for subsequent processing;
wherein the memory bears software instructions that enable the route processor to effect the steps:
generating the step intervals for a route; and
generating a route based on the step interval; and
receiving the solution space data;
generating the step intervals for a route; and
generating a route based on the step interval;
wherein the memory bears software instructions that enable the encryption engine processor to effect the step of decrypting frames of encrypted wideband digital data using the decryption mode of a non-algebraic encryption engine to produce frames of clear text wideband digital data; and
wherein the memory bears software instructions that enable the output processor to effect the steps:
receiving and storing clear text ancillary data;
receiving and storing frames of clear text wideband digital data;
placing the frames of clear text data wideband digital data in the order of the frames of wideband digital data prior to encryption; and
sending the clear text wideband digital data to a user device.

14. The device architecture of claim 13 wherein the device is an integrated circuit.
